(19) United States
(12) Patent Application Publication
(10) Pub. No.: US 2014/0126773 A1
(43) Pub. Date: May 8, 2014

(54) COMMODITY RECOGNITION APPARATUS AND COMMODITY RECOGNITION METHOD

(71) Applicant: TOSHIBA TEC KABUSHIKI KAISHA, Tokyo (JP)

(72) Inventors: Hidehiko Miyakoshi, Miyagi-ken (JP); Hiroshi Sugasawa, Miyagi-ken (JP)

(73) Assignee: TOSHIBA TEC KABUSHIKI KAISHA, Tokyo (JP)

(21) Appl. No.: 14/065,512

(22) Filed: Oct. 29, 2013

(30) Foreign Application Priority Data
Nov. 5, 2012 (JP) 2012-243645

(51) Int. Cl. G06K 9/62

(52) U.S. Cl. CPC G06K 9/6202
USPC 382/103

(57) ABSTRACT

A commodity recognition apparatus comprises a feature amount extraction unit configured to extract the appearance feature amount of a commodity contained in an image captured by an image capturing section; a distance measurement unit configured to measure the distance from the image capturing section to a commodity captured by the image capturing section; a file selection unit configured to select a recognition dictionary file corresponding to the distance measured by the distance measurement unit from the recognition dictionary files for each distance.

### CROSS-REFERENCE TO RELATED APPLICATION

This application is based upon and claims the benefit of priority from Japanese Patent Application No. 2012-243645, filed Nov. 5, 2012, the entire contents of which are incorporated herein by reference.

### FIELD

Embodiments described herein relate to a commodity recognition apparatus for recognizing a commodity from the image data captured by an image capturing section and a commodity recognition method for enabling a computer to function as the commodity recognition apparatus.

### BACKGROUND

There is a technology in which the appearance feature amount of a commodity (object) is extracted from the image data of the commodity captured by an image capturing section and a similarity degree is calculated by comparing the extracted feature amount with the feature amount data of a reference image registered in a recognition dictionary file to recognize the category of the commodity according to the calculated similarity degree. Such a technology for recognizing the commodity contained in the image is called as a general object recognition. As to the technology of the general object recognition, various recognition technologies are described in the following document.

Keiji Yanai “Present situation and future of general object recognition”, Journal of Information Processing Society, Vol. 48, No. SIG16 [Search on Heisei 22 August 10], Internet <URL: http://mm.cs.uec.ac.jp/IPSJ-TCVIM-Yanai.pdf>

In addition, the technology carrying out the general object recognition by performing an area-division on the image for each object is described in the following document.

Jamie Shotton etc., “Semantic Texton Forests for Image Categorization and Segmentation”, [Search on Heisei 22 August 10], Internet <URL: http://citeseerx.ist.psu.edu/viewdoc/download?doi=10.1.1.14 5.3036&rep=repl&type=pdf>

In recent years, for example, there is a proposal in which the general object recognition technology is applied to a recognition apparatus for recognizing a commodity purchased by a customer, especially, a commodity without a barcode, such as, vegetables, fruits and the like in a checkout system (POS system) of a retail store. In this case, an operator (shop clerk or customer) holds a commodity to be recognized towards an image capturing section, however, the distance from the image capturing section to the held commodity is unfixed. On the other hand, as the pixels of the image capturing section are fixed, the resolution of the captured image is changed with the distance between the image capturing section and the commodity. As a result, the similarity degree between the appearance feature amount of the commodity extracted from the captured image and the feature amount data of a reference image is reduced due to the difference in resolutions of the captured image and the reference image, which may lead to a low recognition rate.

### BRIEF DESCRIPTION OF THE DRAWINGS

FIG. 1 is an external view of a store checkout system according to an embodiment;

FIG. 2 is a block diagram illustrating hardware arrangement of a scanner apparatus and a POS terminal of the store checkout system;

FIG. 3 is a schematic view illustrating a structure of dictionary data for each commodity stored in a recognition dictionary file in a first embodiment;

FIG. 4 is a schematic view illustrating a data structure of a determination table;

FIG. 5 is a schematic view illustrating a state in which a commodity is held to a reading window of a scanner apparatus and an example of a frame image captured in this state;

FIG. 6 is a schematic view illustrating a state in which a commodity is held to a reading window of a scanner apparatus and an example of a frame image captured in this state;

FIG. 7 is a block diagram illustrating functions of a scanner apparatus serving as a commodity recognition apparatus in the first embodiment;

FIG. 8 is a flowchart illustrating a main procedure of an information processing executed by a CPU of a scanner apparatus in accordance with a commodity recognition program in the first embodiment;

FIG. 9 is a flowchart specifically illustrating a procedure of a recognition processing in FIG. 8;

FIG. 10 is a diagram illustrating an example of a screen displayed on a touch panel when image capturing distance is short;

FIG. 11 is a diagram illustrating an example of a screen displayed on a touch panel when image capturing distance is moderate;

FIG. 12 is a diagram illustrating an example of a screen displayed on a touch panel when image capturing distance is far;

FIG. 13 is a schematic view illustrating a constitution of a recognition dictionary file in a second embodiment;

FIG. 14 is a schematic view illustrating a structure of dictionary data for each commodity stored in a recognition dictionary file in the second embodiment;

FIG. 15 is a block diagram illustrating functions of a scanner apparatus serving as a commodity recognition apparatus in the second embodiment;

FIG. 16 is a flowchart illustrating a main procedure of an information processing executed by a CPU of a scanner apparatus in accordance with a commodity recognition program in the second embodiment;

FIG. 17 is a flowchart specifically illustrating the first half part of a procedure of a recognition processing in FIG. 8; and

FIG. 18 is a flowchart specifically illustrating the second half part of a procedure of a recognition processing in FIG. 8.

### DETAILED DESCRIPTION

In accordance with an embodiment, a commodity recognition apparatus comprises a feature amount extraction unit, a distance measurement unit, a file selection unit, a similarity degree calculation unit, and a candidate output unit. The feature amount extraction unit extracts an appearance feature amount of a commodity contained in an image captured by an image capturing section for capturing a commodity. The distance measurement unit measures the distance from the image capturing section to a commodity captured by the image capturing section. The file selection unit selects a recognition dictionary file corresponding to the distance measured by the distance measurement unit from the recognition dictionary files for each distance which stores, for each image capturing distance when capturing a recognition target commodity, feature amount data representing the surface information of the recognition target commodity obtained from an image of the recognition target commodity captured at the image capturing distance. The similarity degree calculation unit calculates, for each recognition target commodity, a similarity degree representing how similar the appearance feature amount is to the feature amount data by comparing the appearance feature amount extracted by the feature amount extraction unit with the feature amount data of the recognition dictionary file selected by the file selection unit. The candidate output unit outputs a recognition target commodity as a candidate of a recognized commodity based on the similarity degrees calculated by the similarity degree calculation unit.

Embodiments of the commodity recognition apparatus is described below with reference to accompanying drawings. Further, in the present embodiment, a scanner apparatus 1 constituting a store checkout system of a retail store which deals in vegetables, fruits and the like has a function of a commodity recognition apparatus.

### Embodiment 1

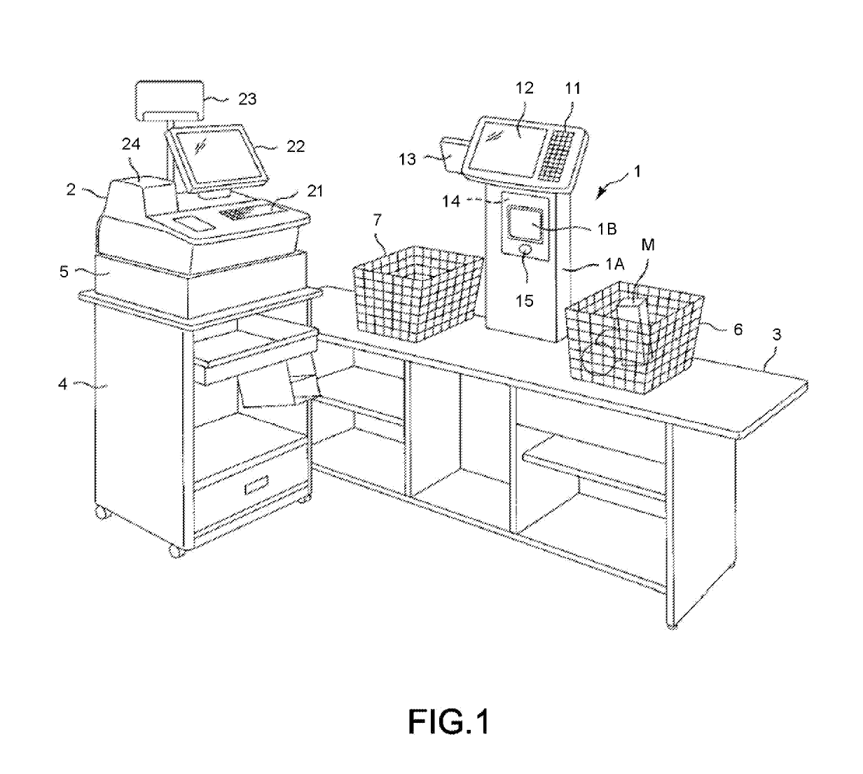

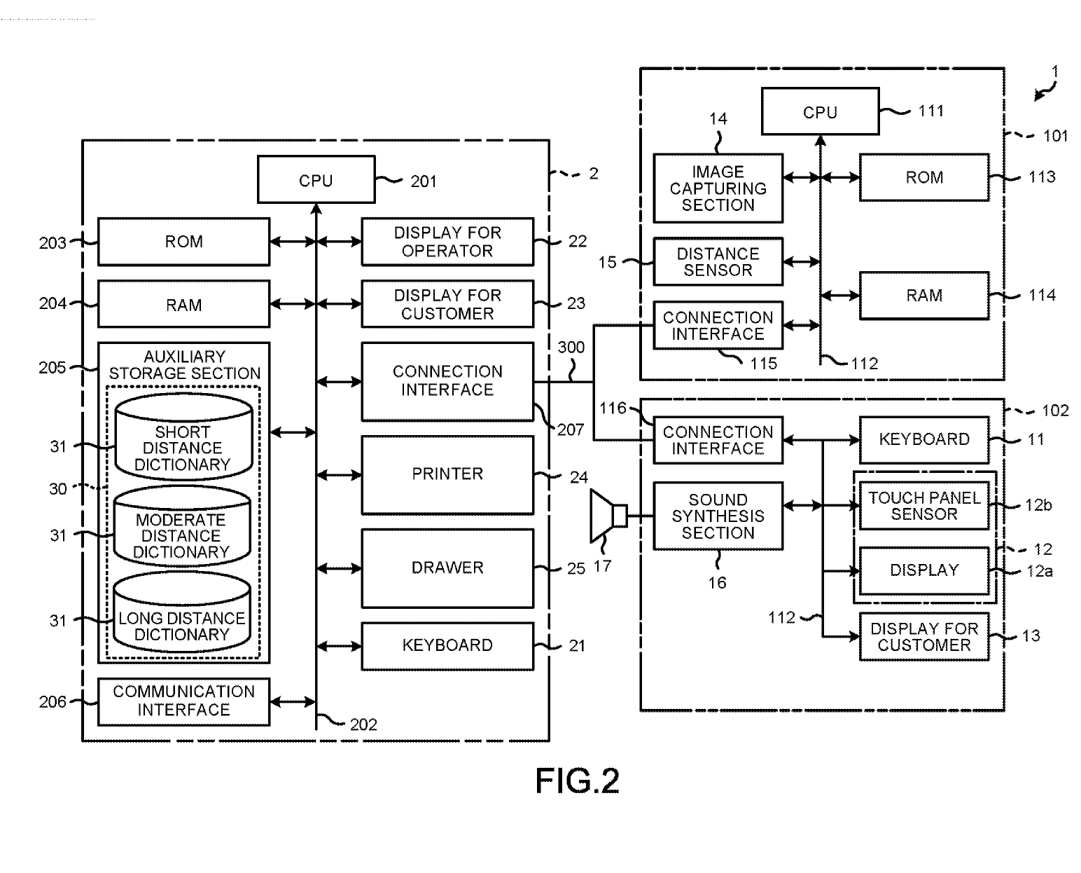

FIG. 1 is an external view of a store checkout system. The system comprises a scanner apparatus 1 functioning as a registration section for registering the commodities purchased by a customer and a POS (Point Of Sales) terminal 2 functioning as a settlement section for processing a payment of the customer. The scanner apparatus 1 is arranged on a checkout counter 3. The POS terminal 2 is arranged on a register table 4 across a drawer 5. The scanner apparatus 1 is electrically connected with the POS terminal 2 via a communication cable 300 (refer to FIG. 2).

The scanner apparatus 1 comprises a keyboard 11, a touch panel 12 and a display for customer 13. These display and operation devices (the keyboard 11, the touch panel 12 and the display for customer 13) are arranged on a thin rectangular housing 1A constituting a main body of the scanner apparatus 1.

An image capturing section 14 is arranged in the housing 1A. In addition, a rectangular reading window 1B is formed on the front side of the housing 1A. The image capturing section 14 comprises a CCD (Charge Coupled Device) image capturing element serving as an arean image sensor and a drive circuit thereof as well as an imaging lens for focusing an image of an image capturing area on the CCD image capturing element. The image capturing area refers to an area of a frame image which is focused on the area of the CCD image capturing element by the imaging lens through the reading window 1B. The image capturing section 14 outputs an image of the image capturing area focused on the CCD image capturing element by the imaging lens. Further, the image capturing section may also be a CMOS (complementary metal oxide semiconductor) image sensor.

A distance sensor 15 serving as a distance measurement unit 72 which will be described later is arranged nearby the reading window 1B. The distance sensor 15 measures the distance from the image capturing section 14 to a commodity captured by the image capturing section 14. The distance sensor 15 may be a device in which an infrared ray LED and a phototransistor are combined or a well-known distance sensor using an ultrasonic or laser light.

The POS terminal 2 comprises a keyboard 21, a display for operator 22, a display for customer 23 and a receipt printer 24 as devices required for settlement.

The checkout counter 3 is formed in an elongated-shape along a customer passage at the rear side of the checkout counter. The register table 4 is arranged at substantially right angle to the checkout counter 3 at the rear side of the end of the checkout counter 3 at the downstream side in the movement direction of a customer moving along the checkout counter 3. The checkout counter 3 and the register table 4 define a space for a shop clerk in charge of settlement, i.e., so called casher.

At the center of the checkout counter 3, the housing 1A of the scanner apparatus 1 is vertically arranged such that the keyboard 11, the touch panel 12 and the reading window 1B are directed to the space for a cashier. The display for customer 13 of the scanner apparatus 1 is arranged on the housing 1A, facing to the customer passage.

A first upper surface portion of the checkout counter 3 at the upstream side of the scanner apparatus 1 in the customer movement direction serves as a space for placing a shopping basket 6 in which an unregistered commodity M purchased by a customer is held. On the other side, a second upper surface portion at the downstream side of the scanner apparatus 1 serves as an another space for placing a shopping basket 7 in which a commodity M registered by the scanner apparatus 1 is held.

FIG. 2 is a block diagram illustrating the hardware arrangement of the scanner apparatus 1 and the POS terminal 2. The scanner apparatus 1 comprises a scanner section 101 and an operation-output section 102. The scanner section 101 carries a CPU (Central Processing Unit) 111 as amain body of a control section. The CPU 111 is connected with a ROM (Read Only Memory) 113 and a RAM (Random Access Memory) 114 via a bus line 112 such as an address bus, a data bus and the like. A program, such as a commodity recognition program which will be described later, executed by the CPU 111 is stored in the ROM 113.

The bus line 112 is connected with the image capturing section 14 and the distance sensor 15 via an input-output circuit (not shown). Further the bus line 112 is extended through a connection interface 115 and a connection interface 116, and the keyboard 11, the touch panel 12, and the display for customer 13 are connected with the bus line 112. The touch panel 12 comprises a panel-type display 12a and a touch panel sensor 12b overlapped on the screen of the display 12a. Further, a sound synthesis section 16 is also connected with the bus line 112. The sound synthesis section 16 outputs a sound signal to a speaker 17 according to a command input through the bus line 112. The speaker 17 converts the sound signal to sound and output the sound.

The connection interface 116 and the keyboard 11, the touch panel 12, the display for customer 13 and the sound synthesis section 16 constitute the operation-output section 102. Each section constituting the operation-output section 102 is controlled not only by the CPU 111 of the scanner section 101 but also by a CPU 201 of the POS terminal 2 described below.

The POS terminal 2 also carries a CPU 201 as a main body of a control section. The CPU 201 is connected with a ROM 203, a RAM 204, an auxiliary storage section 205, a communication interface 206 and a connection interface 207 via a bus line 202. In addition, the keyboard 21, display for operator 22, display for customer 23, printer 24 and drawer 5 are respectively connected with the bus line 202 via the input-output circuit (not shown).

The communication interface 206 is connected with a store server (not shown) serving as the center of a store via a network such as a LAN (Local Area Network) and the like. Through this connection, the POS terminal 2 can perform a transmission/reception of data with the store server.

The connection interface 207 is connected with the two connection interfaces 115 and 116 of the scanner apparatus 1 via the communication cable 300. Through the connection, the POS terminal 2 receives information from the scanner section 101 of the scanner apparatus 1. In addition, the POS terminal 2 performs a transmission/reception of data signals with the keyboard 11, the touch panel 12, the display for customer 13 and the sound synthesis section 16 which constitute the operation-output section 102 of the scanner apparatus 1. On the other hand, through the connection, the scanner apparatus 1 accesses a data file stored in the auxiliary storage section 205 of the POS terminal 2.

The auxiliary storage section 205, which is, for example, an HDD (Hard Disk Drive) apparatus or a SSD (Solid State Drive) apparatus, stores data files such as a recognition dictionary file 30 and the like in addition to various programs. The recognition dictionary file 30 includes a short distance dictionary file 31, a moderate distance dictionary file 32 and a long distance dictionary file 33.

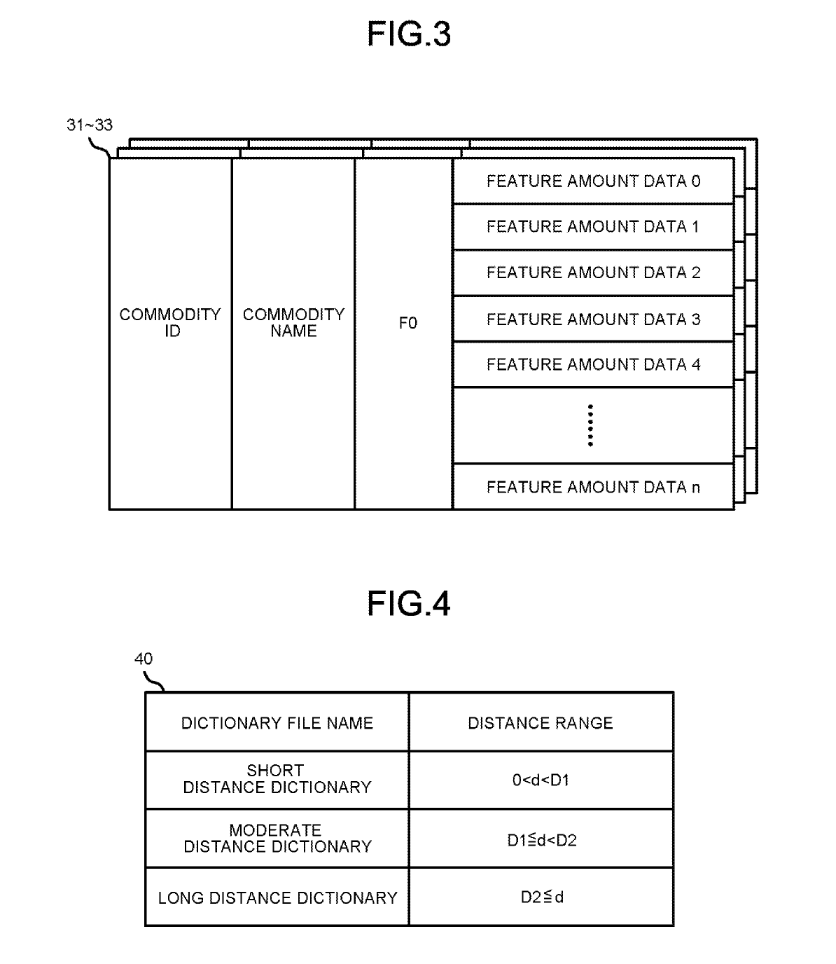

FIG. 3 is a schematic view illustrating a structure of dictionary data for each commodity stored in each recognition dictionary file 31-33. As shown in FIG. 3, dictionary data for each commodity include a commodity ID and a commodity name for recognizing a recognition target commodity, a proper distance flag F0 and a feature amount data. The proper distance flag F0 is described later. The feature amount data is a data obtained by extracting appearance feature amount, that is, surface information (an appearance shape, a color, a pattern, a concave-convex and the like) of a commodity from a captured reference image of a commodity identified with the corresponding commodity ID, and representing the appearance feature amount in the form of parameters. A plurality of feature amount data (0 to n) of a commodity observed from different directions are respectively stored for one recognition target commodity. However, the number of the feature amount data (n+1) is not fixed. For example, the number of the feature amount data (n+1) is different from one another according to various kinds of commodities. Further, commodity name is not necessarily contained in the dictionary data for each commodity.

The short distance dictionary file 31 stores dictionary data for each commodity which contains the feature amount data acquired from a reference image obtained by capturing a recognition target commodity when the image capturing distance, that is the distance between the image capturing unit (camera) and a commodity, is shorter than a preset first distance D1 (cm). The moderate distance dictionary file 32 stores dictionary data for each commodity which contains the feature amount data acquired from a reference image captured when the image capturing distance is longer than or equal to the first distance D1 but shorter than a second distance D2 (cm) longer than the first distance D1. The long distance dictionary file 33 stores dictionary data for each commodity which contains the feature amount data acquired from a reference image captured when the image capturing distance is longer than or equal to the second distance D2.

In the present embodiment, dictionary data for each recognition target commodity is respectively stored in the short distance dictionary file 31, the moderate distance dictionary file 32 and the long distance dictionary file 33. That is, for each recognition target commodity, there is prepared a first reference mage captured when the image capturing distance is shorter than the first distance D1, a second reference mage captured when the image capturing distance is longer than or equal to the first distance D1 but shorter than the second distance D2 and a third reference mage captured when the image capturing distance is longer than or equal to the second distance D2, and feature amount data is respectively acquired from each reference image to create dictionary data for each commodity, and the dictionary data for each commodity is registered in corresponding recognition dictionary files 31-33 for each image capturing distance.

The relation between an image capturing distance and a recognition rate is described herein.

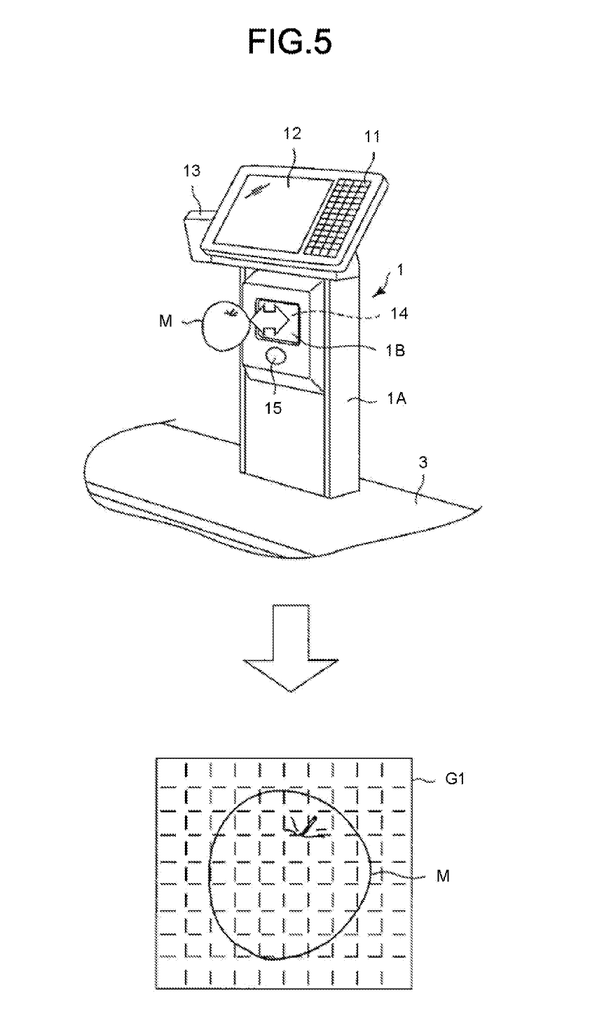

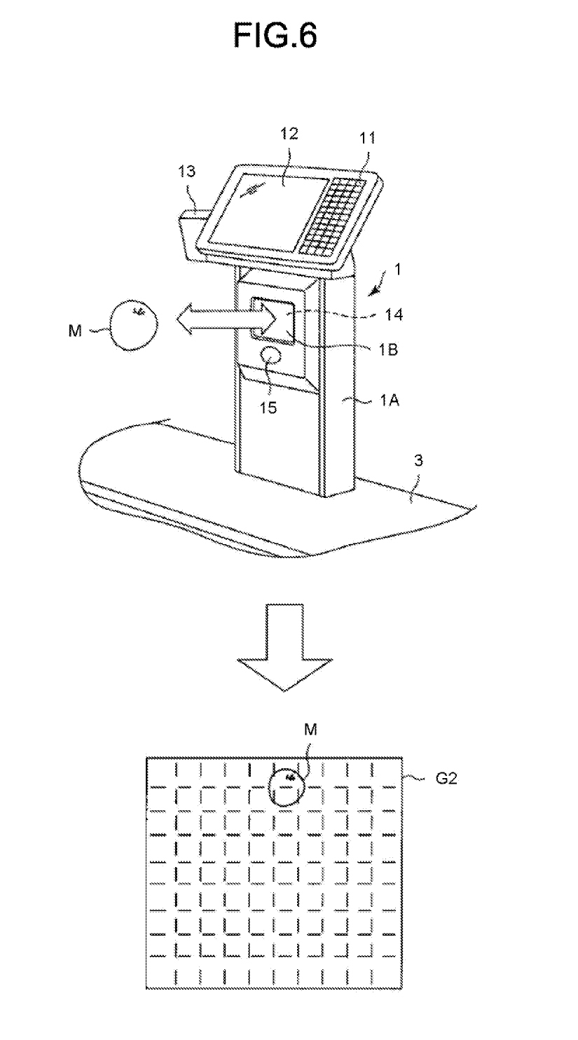

FIG. 5 and FIG. 6 are schematic views illustrating a state in which a commodity (apple) M is held to the reading window 1B of the scanner apparatus 1 and examples of frame images G1 and G2 captured in this state. FIG. 5 illustrates a case where the image capturing distance is short (distance=d1), and FIG. 6 illustrates a case where the image capturing distance is long (distance=d2: d2>d1).

It can be known by comparing the frame image G1 shown in FIG. 5 with the frame image G2 shown in FIG. 6 that the commodity M is imaged in a big size with respect to the size of the frame image G1 when the image capturing distance, that is, the distance between the reading window 1B and the commodity M is short and the commodity M is imaged in a small size with respect to the size of the frame image G2 when the image capturing distance, that is, the distance between the reading window 1B and the commodity M is far. As a result, if the frame image G1 and the frame image G2 are distinguished with cells of the same size in a lattice form, then the number of the cells imaging the commodity M in a case where the image capturing distance is far is smaller than that of the cells imaging the commodity M in a case where the image capturing distance is short. That is, the resolution of the commodity M imaged on the frame image G1 is improved when the image capturing distance is short and reduced when the image capturing distance is far.

In general object recognition technologies, there is a tendency that the closer the resolution of an image captured by the image capturing section 14 is to the resolution of a reference image, the higher the recognition rate is. That is, as shown in FIG. 5, when the distance between the reading window 1B and the commodity M is short, the recognition rate is high if the feature amount data stored in the short distance dictionary file 31 or the moderate distance dictionary file 32 is used and is low if the feature amount data stored in the long distance dictionary file 33 is used. On the contrary, as shown in FIG. 6, when the distance between the reading window 1B and the commodity M is long, the recognition rate is high if the feature amount data stored in the long distance dictionary file 33 or the moderate distance dictionary file 32 is used and is low if the feature amount data stored in the short distance dictionary file 31 is used.

On the other hand, different categories of commodities have different sizes. For example, even for the same category of citrus, there are small ‘tangerine’ and big ‘pomelo’. In a case where the size of the recognition target commodity is small, if the recognition target commodity is captured at an image capturing distance greater than the second distance D2 to obtain feature amount data for use in the long distance dictionary file 33, then the resolution of the reference image is significantly reduced. Consequentially, feature amount data with high-reliability cannot be obtained. Contrarily, in a case where the size of the recognition target commodity is large, if the recognition target commodity is captured at an image capturing distance smaller than the first distance D1 to obtain feature amount data for use in the short distance dictionary file 31, then the image of the commodity is out of the range of the frame, and as a consequence, feature amount data with high-reliability cannot be obtained either. Low-reliability feature amount data means a low-reliability recognition result. That is, when recognizing a commodity, there is a proper image capturing distance according to the size of the commodity.

In the present embodiment, for each recognition target commodity, the proper distance Flag F0 of the dictionary data for each commodity including the feature amount data generated from a reference image captured at a proper image capturing distance is set to be 1, and the proper distance Flag F0 of the dictionary data for each commodity including the feature amount data generated from a reference image captured at an improper image capturing distance is set to be 0.

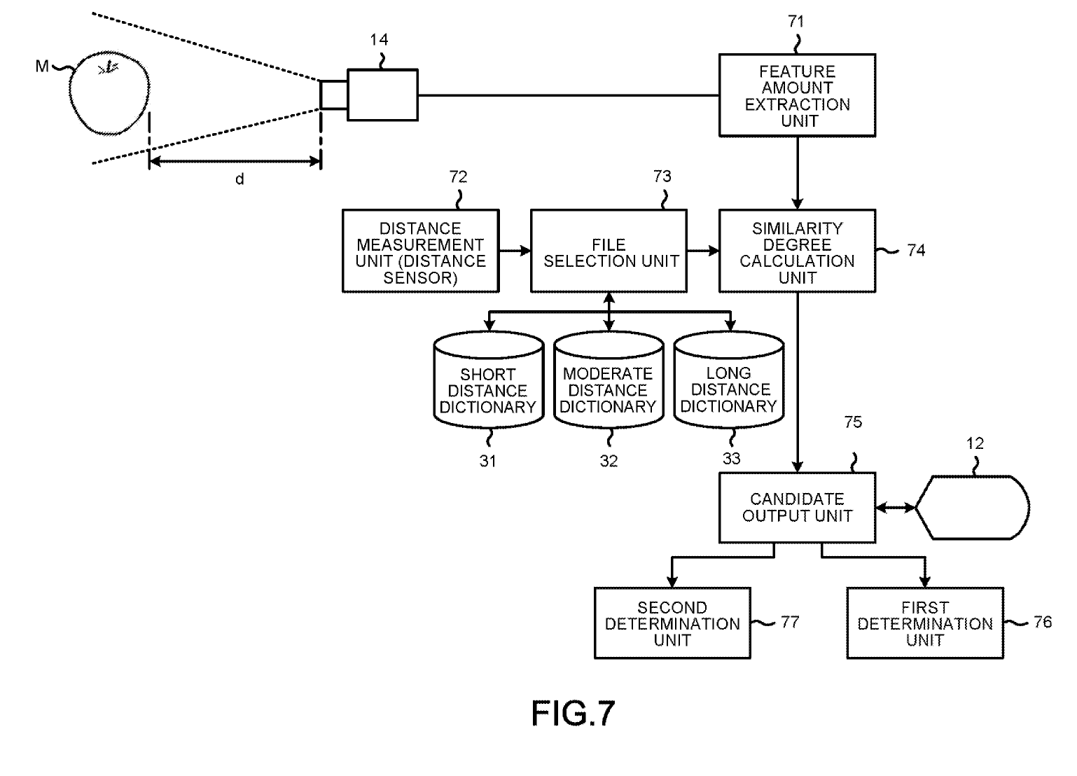

FIG. 7 is a block diagram illustrating functions as a commodity recognition apparatus. In the present embodiment, the scanner apparatus 1 has the functions. That is, in the scanner apparatus 1, a feature amount extraction unit 71, a distance measurement unit 72, a file selection unit 73, a similarity degree calculation unit 74, a candidate output unit 75, a first determination unit 76 and a second determination unit 77 are arranged to realize a function of recognizing and determining a commodity M held to the image capturing area of the image capturing section 14 as a commodity for sale.

The feature amount extraction unit 71 extracts the appearance feature amount of a commodity M contained in an image captured by the image capturing section 14. The distance measurement unit 72 (distance sensor 15) measures the distance from the image capturing section 14 to a commodity M captured by the image capturing section 14. The file selection unit 73 selects a recognition dictionary file 3X (X=1, 2 or 3) corresponding to the distance measured by the distance measurement unit 72 from the recognition dictionary files for each image capturing distance (short distance dictionary file 31, moderate distance dictionary file 32, long distance dictionary file 33).

The file selection unit 73 uses a determination table 40 having the data structure shown in FIG. 4. The determination table 40 is a table which is stored in, for example, the RAM 114 and sets, in association with a dictionary file name for respectively recognizing the short distance dictionary file 31, the moderate distance dictionary file 32 and the long distance dictionary file 33, the range of an image capturing distance d relating to the dictionary data for each commodity registered in the corresponding dictionary file. That is, a range of smaller than the first distance D1 is set in association with the dictionary file name of the short distance dictionary file 31, a range of greater than or equal to the first distance D1 but smaller than the second distance D2 is set in association with the dictionary file name of the moderate distance dictionary file 32, and a range of greater than or equal to the second distance D2 is set in association with the dictionary file name of the long distance dictionary file 33. The file selection unit 73 selects the recognition dictionary file 3X specified by a dictionary file name associated with a range the distance d measured by the distance measurement unit 72 is in.

The similarity degree calculation unit 74 calculates, for each recognition target commodity, a similarity degree representing how similar the appearance feature amount is to the feature amount data by comparing the appearance feature amount extracted by the feature amount extraction unit 71 with the feature amount data of the recognition dictionary file 3X selected by the file selection unit 73. The candidate output unit 75 displays and outputs recognition target commodities as candidates of a recognized commodity on the touch panel 12 to be selectable based on the similarity degree calculated by the similarity degree calculation unit 74.

The first determination unit 76 determines the recognition target commodity selected from the commodities of a recognized commodity displayed on the touch panel 12 as a commodity M captured by the image capturing section 14. The second determination unit 77 determines, in a case where the highest similarity degree of the recognition target commodity output by the candidate output unit 75 as a candidate of a recognized commodity is above a preset determination value and the highest similarity degree is calculated according to the feature amount data acquired from the reference image captured at a proper image capturing distance, the recognition target commodity having the highest similarity degree as a commodity captured by the image capturing section 14.

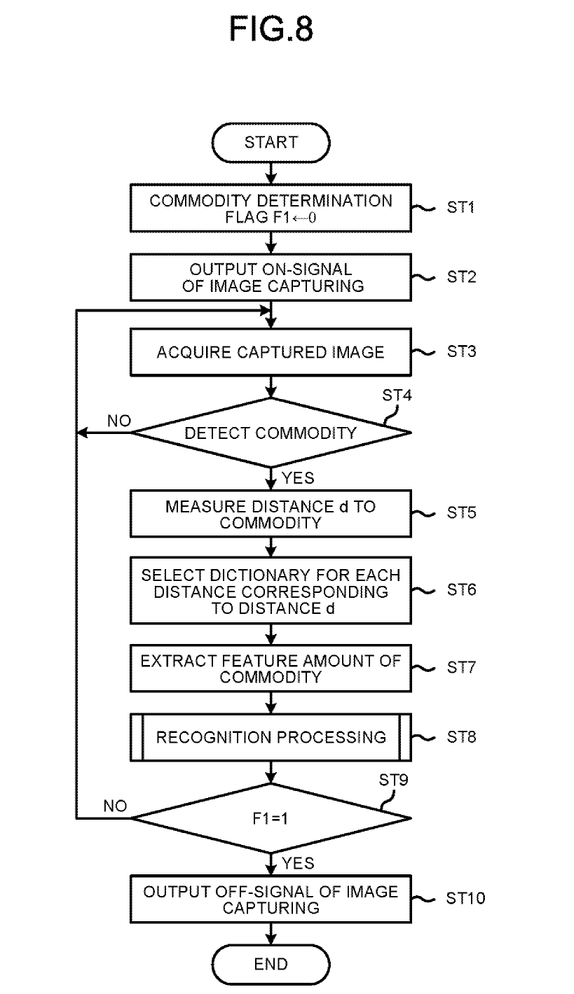

The units 71-77 are realized by the CPU 111 of the scanner apparatus 1 operating in accordance with a commodity recognition program. When the commodity recognition program is started, the CPU 111 of the scanner apparatus 1 controls each section in a procedure shown in the flowchart of FIG. 8.

First, the CPU 111 resets a commodity determination flag F1 which will be described later to be 0 (ACT ST1). The commodity determination flag F1 is stored in the RAM 114. Further, the CPU 111 outputs an ON-signal of image capturing to the image capturing section 14 (ACT ST2). The image capturing section 14 starts to capture an image capturing area according to the ON-signal of image capturing. The frame images of the image capturing area captured by the image capturing section 14 are sequentially stored in the RAM 114. Further, ACT ST1 and ACT ST2 may be carried out in an inverse sequence.

The CPU 111 outputting the ON-signal of image capturing reads a frame image stored in the RAM 114 (ACT ST3). Then, the CPU 111 confirms whether or not a commodity is contained in the frame image (ACT ST4). Specifically, the CPU 111 extracts a contour line from a binary image of the frame image. Then, the CPU 111 tries to extract the contour of an object imaged in the frame image. If the contour line of the object is extracted, the CPU 111 regards the image in the contour line as a commodity.

If a commodity is not contained in the frame image (NO in ACT ST4), the CPU 111 acquires a next frame image from the RAM 114 (ACT ST3). Then, the CPU 111 confirms whether or not a commodity is contained in the frame image (ACT ST4).

If a commodity M is contained in the next frame image (YES in ACT ST4), the CPU 111 activates the distance sensor 15 to measure the image capturing distance d from the image capturing section 14 to the commodity M (ACT ST5: distance measurement unit 74). If the image capturing distance d is measured, the CPU 111 acquires a dictionary file name associated with a distance range the image capturing distance d is in with reference to the determination table 40 and selects a recognition dictionary file 3X (X=1, 2 or 3) specified by the dictionary file name (ACT ST6: file selection unit 73). Further, the CPU 11 extracts appearance feature amount, such as the shape, the surface color, the pattern and the concave-convex situation, of the commodity M from the image in the contour extracted from the frame image (ACT ST6: feature amount extraction unit 71). Further, ACT ST5, ACT ST 6 and ACT ST7 may be carried out in an inverse sequence.

In this way, a recognition dictionary file 3X corresponding to an image capturing distance d is selected, and the appearance feature amount of the commodity M is acquired, then the CPU 111 starts a recognition processing (ACT ST8).

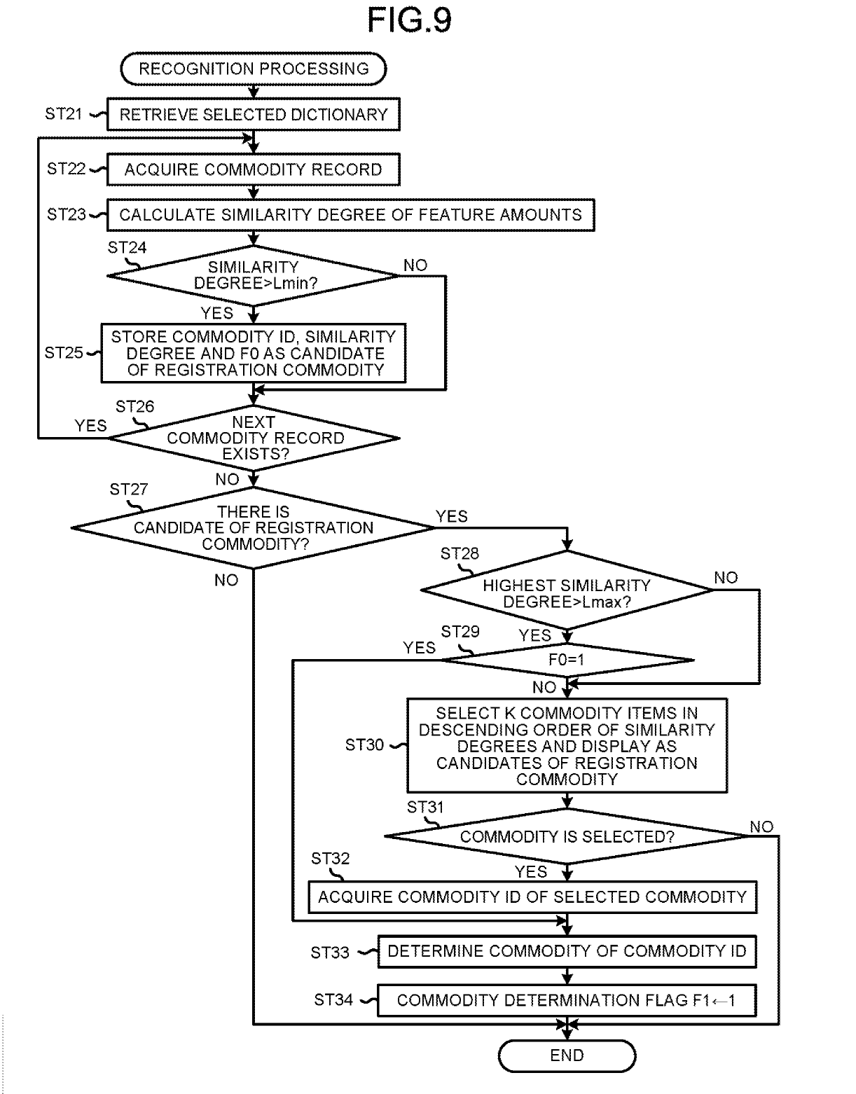

FIG. 9 is a flowchart illustrating a procedure of the recognition processing. First, the CPU 111 accesses the auxiliary storage section 205 of the POS terminal 2 connected via the connection interface 115 and retrieves the selected recognition dictionary file 3X (ACT ST21). Then, the CPU 111 reads a data record (commodity ID, commodity name, proper distance flag F0, feature amount data 0-n) of one commodity from the recognition dictionary file 3X (ACT ST22).

After reading a data record, the CPU 111 calculates, for each feature amount data 0-n of the record, a similarity degree representing how similar the appearance feature amount of the commodity extracted in ACT ST7 is to the feature amount data 0-n. Then, the CPU 111 determines the highest similarity degree calculated for each feature amount data 0-n as the similarity degree between the detected commodity M and the commodity specified with the commodity ID in the record (ACT ST23: similarity degree calculation unit 74). Further, the determined similarity degree may be a total value or an average value of the similarity degrees calculated for each feature amount data 0-n, but not limited to be the highest similarity degree calculated for each feature amount data 0-n.

The CPU 111 confirms whether or not the similarity degree determined in ACT ST23 is greater than a preset candidate threshold value Lmin (ACT ST24). If the similarity degree is not greater than the candidate threshold value Lmin (NO in ACT ST24), the CPU 111 carries out the processing in ACT ST26.

If the similarity degree is greater than the candidate threshold value Lmin (YES in ACT ST24), the CPU 111 stores the commodity ID and the proper distance flag F0 in the record and the similarity degree in the RAM 114 as data of a candidate of a registration commodity (candidate of a recognized commodity) (ACT ST25). Then, the CPU 111 carries out the processing in ACT ST26.

In ACT ST26, the CPU 111 confirms whether or not there is an unprocessed data record in the recognition dictionary file 3X. If there is an unprocessed data record in the recognition dictionary file 3X (YES in ACT ST26), the CPU 111 returns to carry out the processing in ACT ST22. That is, the CPU 111 reads the unprocessed data record from the recognition dictionary file 3X and executes the processing shown in ACT ST23-ACT ST25.

If there is no unprocessed data record in the recognition dictionary file 3X, that is, the retrieval in the recognition dictionary file 3X is ended (NO in ACT ST26), the CPU 111 confirms whether or not data of candidates of a registration commodity is stored in the RAM 114 (ACT ST27). The current recognition processing is ended if data of candidates of a registration commodity is not stored in the RAM 114 (NO in ACT ST27).

If the data of the candidates of a registration commodity is stored in the RAM 114 (YES in ACT ST27), the CPU 111 confirms whether or not the highest similarity degree of the data of the candidates of a registration commodity stored in the RAM 114 is greater than a preset determination threshold value Lmax (Lmax>Lmin) (ACT ST28). If the highest similarity degree is not greater than the determination threshold value Lmax (NO in ACT ST28), the CPU 111 selects, in the descending order of similarity degrees, the top K (K>2) commodity items from the data of the candidates of a registration commodity stored in the RAM 114. Then, the CPU 111 displays the selected top K commodity items on the display 12a as a commodity list of candidates of a registration commodity (ACT ST30: candidate output unit 75). Sequentially, the CPU 111 confirms whether or not a commodity is optionally selected from the commodity list (ACT ST31). For example, the CPU 111 ends the current recognition processing if the re-retrieve key on the keyboard 11 is input to announce no selection on a commodity (NO in ACT ST31).

On the other hand, if a commodity is optionally selected from the commodity list of candidates of a registration commodity by operating the touch panel 12 or the keyboard 11 (YES in ACT ST31), the CPU 111 acquires the commodity ID of the selected commodity from the RAM 114 (ACT ST32). Then, the CPU 111 determines the acquired commodity ID as the commodity ID of a commodity for sale and sends the acquired commodity ID to the POS terminal 2 via a communication cable 300 (ACT ST33: first determination unit 76). Further, the CPU 111 sets the commodity determination flag F1 to be 1 (ACT ST34). Then, the current recognition processing is ended.

Further, if the highest similarity degree of the data of the candidates of a registration commodity is greater than the determination threshold value Lmax (YES in ACT ST28), the CPU 111 checks the proper distance flag F0 contained in the data of the candidates of a registration commodity (ACT ST29). When the proper distance flag F0 is reset to be 0 (NO in ACT ST29), the highest similarity degree is a similarity degree calculated according to the feature amount data generated from a reference image captured at an improper image capturing distance, thus, the flow proceeds to ACT ST30. That is, the CPU 111 displays the top K commodity items selected, in the descending order of similarity degrees, from the data of the candidates of a registration commodity on the display 12a as a commodity list of candidates of a registration commodity. Then, the CPU 111 executes the processing in ACT ST31-ACT ST34.

On the contrary, when the proper distance flag F0 is set to be 1 (YES in ACT ST29), the CPU 111 carries out the processing in ACT ST33. That is, the CPU 111 acquires the commodity ID of the commodity having the highest similarity degree from the RAM 114. Then, the CPU 111 determines the acquired commodity ID as the commodity ID of a commodity for sale and sends the acquired commodity ID to the POS terminal 2 via the communication cable 300 (ACT ST33: second determination unit 77). Further, the CPU 111 sets the commodity determination flag F1 to be 1 (ACT ST34). Further, ACT ST33 and ACT ST34 may be carried out in an inverse sequence. Then, the current recognition processing is ended.

The CPU 111 confirms whether or not the commodity determination flag F1 is set to be 1 (ACT ST9) when the recognition processing is ended. If the commodity determination flag F1 is not set to be 1 (NO in ACT ST9), the CPU 111 returns to carry out ACT ST3. That is, the CPU 111 acquires another frame image stored in the RAM 114 (ACT ST3). Then, the CPU 11 executes the processing following ACT ST4 again.

If the commodity determination flag F1 is set to be 1 (YES in ACT ST9), the CPU 111 outputs an OFF-signal of image capturing to the image capturing section 14 (ACT ST10). The image capturing section 14 stops image capturing according to the OFF-signal of image capturing. Then, the commodity recognition program is ended.

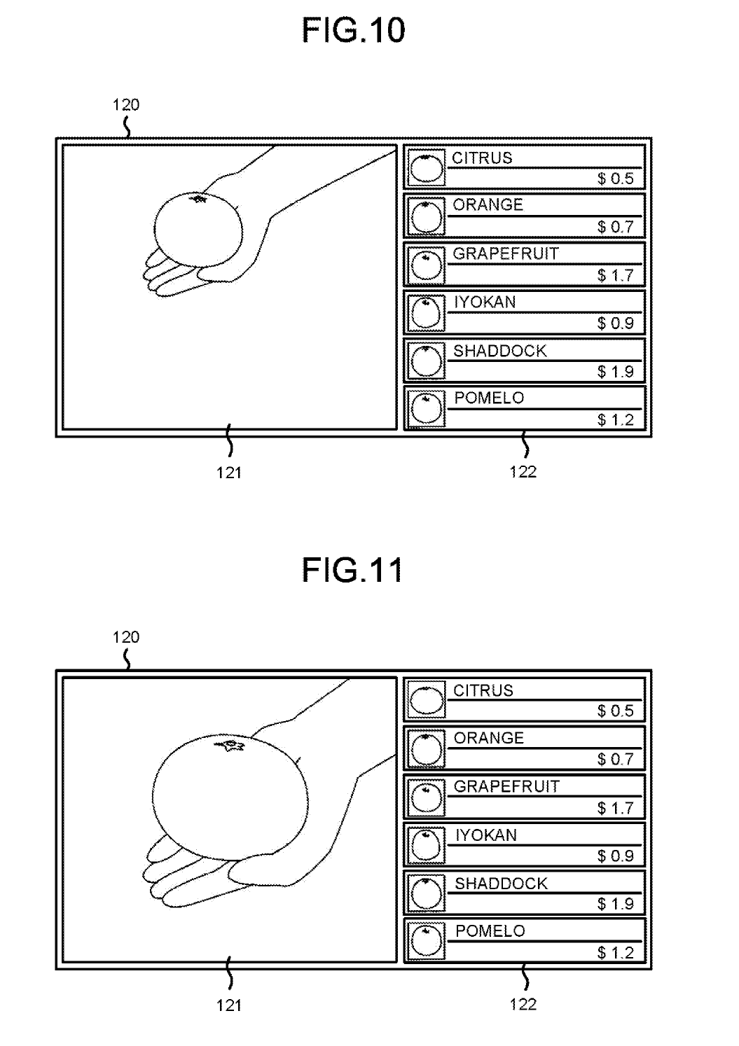

FIG. 10 illustrates an example of a screen 120 displayed on the touch panel 12 when the distance d between a commodity M held to the reading window 1B and the image capturing section 14 is longer than the second distance D2. The screen 120 is divided into an image display area 121 and a commodity candidate area 122. Moreover, the frame image acquired in ACT ST3 is displayed in the image display area 121. Further, the K commodity items (K=6, in FIG. 10) obtained through the recognition processing in ACT ST9 are displayed in the commodity candidate area 122 to be selectable as candidates of a registration commodity using the feature amount data of the long distance dictionary file 33 selected in ACT ST6.

The dictionary data for each commodity including the feature amount data acquired from a reference image captured when the image capturing distance is longer than the second distance D2 is stored in the long distance dictionary file 33. Thus, a high recognition rate is achieved as the resolution of image of the commodity M captured by the image capturing section 14 is highly approximate to that of the reference image.

FIG. 11 illustrates an example of a screen 120 displayed on the touch panel 12 when the distance d between a commodity M held to the reading window 1B and the image capturing section 14 is longer than or equal to the first distance D1 but shorter than the second distance D2. The screen 120 is divided into an image display area 121 and a commodity candidate area 122. Moreover, the frame image acquired in ACT ST3 is displayed in the image display area 121. Further, the K commodity items (K=6, in FIG. 11) obtained through the recognition processing in ACT ST9 are displayed in the commodity candidate area 122 to be selectable as candidates of a registration commodity using the feature amount data of the moderate distance dictionary file 32 selected in ACT ST6.

The dictionary data for each commodity including the feature amount data acquired from a reference image captured when the image capturing distance is longer than or equal to the first distance D1 but shorter than the second distance D2 (cm) longer than the first distance D1 is stored in the moderate distance dictionary file 32. Thus, a high recognition rate is achieved as the resolution of image of the commodity M captured by the image capturing section 14 is highly approximate to that of the reference image.

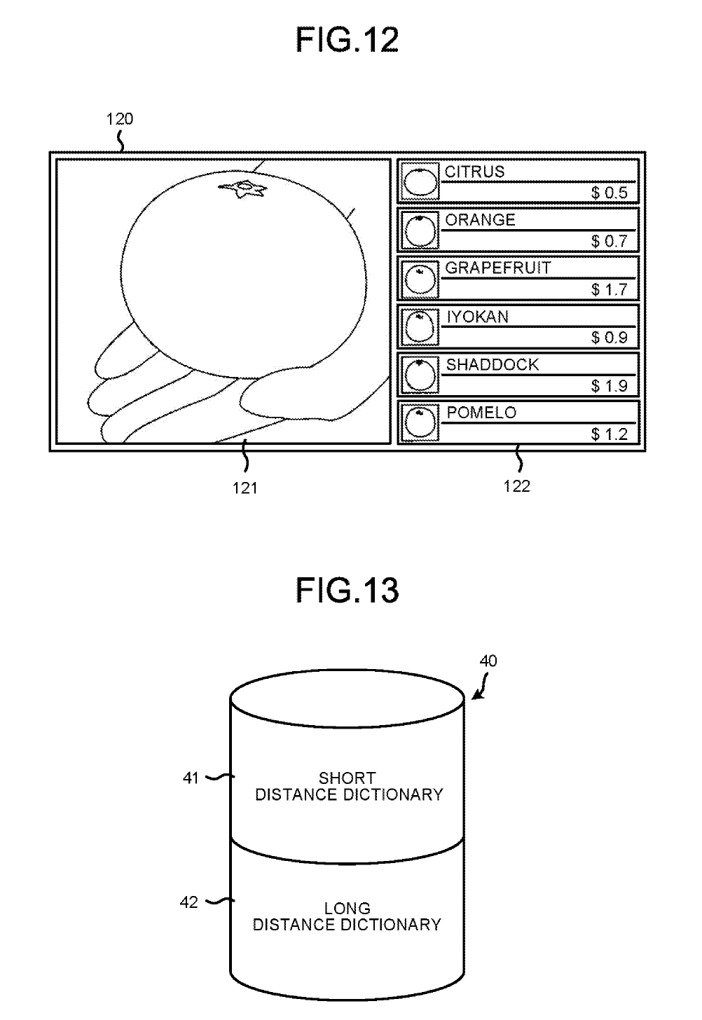

FIG. 12 illustrates an example of a screen 120 displayed on the touch panel 12 when the distance d between a commodity M held to the reading window 1B and the image capturing section 14 is shorter than the first distance D1. The screen 120 is divided into an image display area 121 and a commodity candidate area 122. Moreover, the frame image acquired in ACT ST3 is displayed in the image display area 121. Further, the K commodity items (K=6, in FIG. 12) obtained through the recognition processing of ACT ST9 are displayed in the commodity candidate area 122 to be selectable as candidates of a registration commodity using the feature amount data of the short distance dictionary file 31 selected in ACT ST6.

The dictionary data for each commodity including the feature amount data acquired from a reference image captured when the image capturing distance is shorter than the first distance D1 (cm) is stored in the short distance dictionary file 31. Thus, a high recognition rate is achieved as the resolution of image of the commodity M captured by the image capturing section 14 is highly approximate to that of the reference image.

When the commodity M is included in the candidates of a registration commodity, the user selects the commodity M by touching the commodity. In this way, the commodity M is determined to be a commodity for sale, and the sales of the commodity M is registered in the POS terminal 2.

Further, it is determined whether or not the highest similarity degree of the candidates of a registration commodity is greater than the determination threshold value Lmax in the scanner apparatus 1 before the candidates of a registration commodity are displayed. Sequentially, if the highest similarity degree is greater than the determination threshold value Lmax, the proper distance flag F0 of the data of the candidate of a registration commodity having the highest similarity degree is checked. Herein, if the proper distance flag F0 is set to be 1, the commodity specified with the commodity ID of the candidate of a registration commodity having the highest similarity degree is automatically determined as a commodity for sale, and the sales of the commodity is registered in the POS terminal 2.

For example, the size of a commodity ‘tangerine’ is small. Therefore, in the dictionary data for each commodity of the recognition target commodity ‘tangerine’ registered in the short distance dictionary file 31, the proper distance flag F0 is set to be 1 to represent a high reliability. In this case, the short distance dictionary file 31 is selected in the scanner apparatus 1 when the user holds the commodity ‘tangerine’ to the image capturing section 14 at a distance shorter than the first distance D1. Then, the similarity degree between the appearance feature amount of the commodity ‘tangerine’ acquired from the captured image and the feature amount data of the recognition target commodity ‘tangerine’ registered in the short distance dictionary file 31 is calculated. Herein, if the similarity degree is the highest similarity degree and greater than the determination threshold value Lmax, the sales of the commodity ‘tangerine’ is automatically registered in the POS terminal 2. Therefore, the user can determine the commodity to be a commodity for sale without selecting a corresponding commodity M from the candidates of a registration commodity.

Thus, according to the present embodiment, as a commodity recognition processing is carried out by making a switch among the recognition dictionary files 31-33 used according to the image capturing distance d between a commodity held to the reading window 1B and the image capturing section 14, the scanner apparatus 1 can recognize a commodity at a high recognition rate regardless of the image capturing distance d.

### Embodiment 2

Next, embodiment 2 is described below with reference to FIG. 13-FIG. 18. Further, in embodiment 2, a scanner apparatus 1 is also capable of functioning as a commodity recognition apparatus, like in embodiment 1. Thus, the external view of a store checkout system and the block diagram illustrating hardware arrangement of the scanner apparatus 1 and the POS terminal 2 are shared in embodiments 1 and 2, thus, the same parts are denoted by the same reference signs and are therefore not described here in detail.

FIG. 13 is a schematic view illustrating a recognition dictionary file 40 used in embodiment 2. As shown in FIG. 13, as recognition dictionary file 40, there are a short distance dictionary file 41 and a long distance dictionary file 42 in embodiment 2. The dictionary data for each commodity including the feature amount data acquired from a reference image captured when the image capturing distance is shorter than a preset threshold value distance Dx (cm) is stored in the short dictionary file 41. The dictionary data for each commodity including the feature amount data acquired from a reference image captured when the image capturing distance is greater than the threshold value distance Dx (cm) is stored in the long distance dictionary file 42.

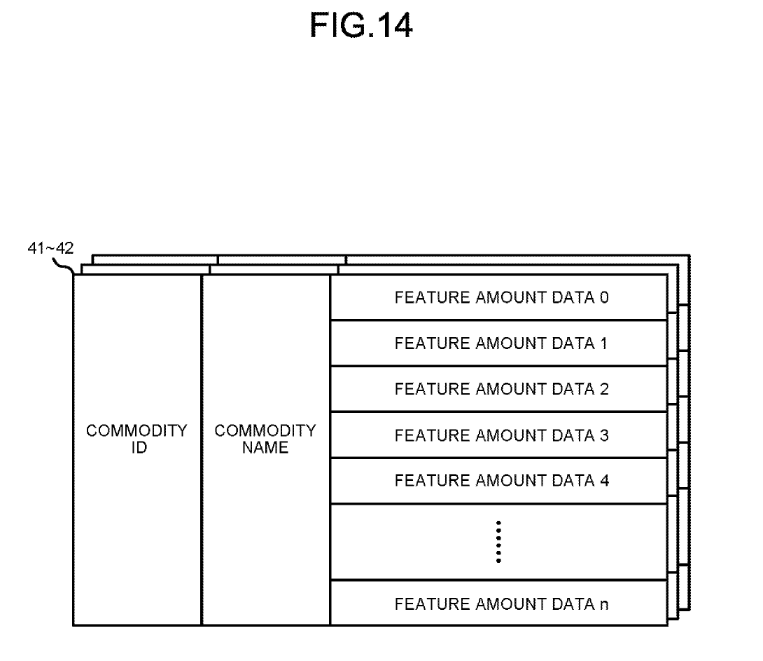

FIG. 14 is a schematic view illustrating the structure of the dictionary data for each commodity stored in the recognition dictionary files 41 and 42. As shown in FIG. 14, the dictionary data for each commodity contains a commodity ID and a commodity name for recognizing a recognition target commodity and a plurality of feature amount data 0-n.

As described in embodiment 1, there is a proper image capturing distance for a recognition target commodity according to the size of the commodity. For example, for a commodity of a small size such as a tangerine, an image capturing distance shorter than the threshold value distance Dx is a proper distance. On the contrary, for a commodity of a large size such as a pomelo, an image capturing distance longer than the threshold value distance Dx is a proper distance.

In the present embodiment, for a recognition target commodity of which a proper image capturing distance is shorter than the threshold value distance Dx, dictionary data for each commodity including the feature amount data acquired from a reference image captured at an image capturing distance shorter than the threshold value distance Dx is stored in the short distance dictionary file 41. The dictionary data for each commodity relating to the recognition target commodity is not stored in the long distance dictionary file 42. On the contrary, for a recognition target commodity of which a proper image capturing distance is greater than the threshold value distance Dx, dictionary data for each commodity including the feature amount data acquired from a reference image captured at an image capturing distance longer than the threshold value distance Dx is stored in the long distance dictionary file 42. The dictionary data for each commodity relating to the recognition target commodity is not stored in the short distance dictionary file 41.

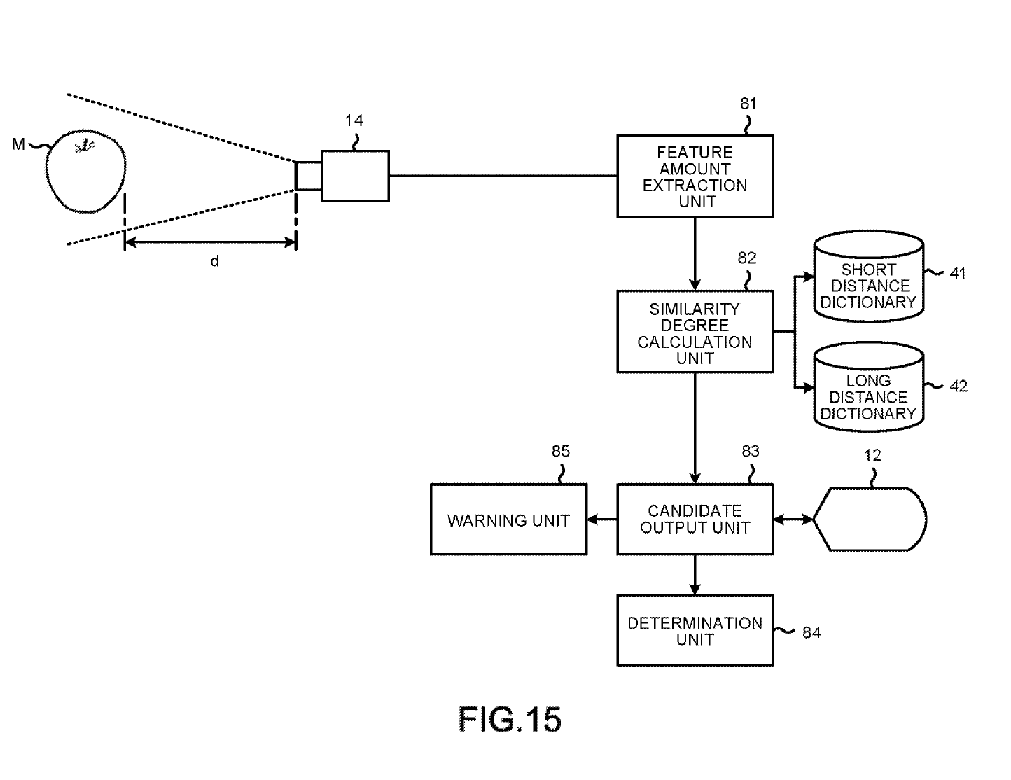

FIG. 15 is a block diagram illustrating the functions as a commodity recognition apparatus. In the present embodiment, the scanner apparatus 1 has the functions. That is, in the scanner apparatus 1, a feature amount extraction unit 81, a similarity degree calculation unit 82, a candidate output unit 83, a determination unit 84 and a warning unit 85 are arranged to realize a function of recognizing and determining a commodity M held to the image capturing area of the image capturing section 14 as a commodity for sale.

The feature amount extraction unit 81 extracts the appearance feature amount of a commodity contained in an image captured by the image capturing section 14. The similarity degree calculation unit 82 calculates, for each recognition target commodity, a similarity degree representing how similar the appearance feature amount is to the feature amount data by comparing the appearance feature amount extracted by the feature amount extraction unit 81 with the feature amount data stored in the distance recognition dictionary file 40 (both the short distance dictionary file 41 and the long distance dictionary file 42). The candidate output unit 83 displays and outputs recognition target commodities as candidates of a recognized commodity on the touch panel 12 to be selectable in the descending order of the similarity degrees calculated by the similarity degree calculation unit 82. The warning unit 85 gives a warning to change the distance between a commodity M captured by the image capturing section 14 and the image capturing section 14 if the commodity M captured by the image capturing section 14 is not selected from the candidates of a recognized commodity.

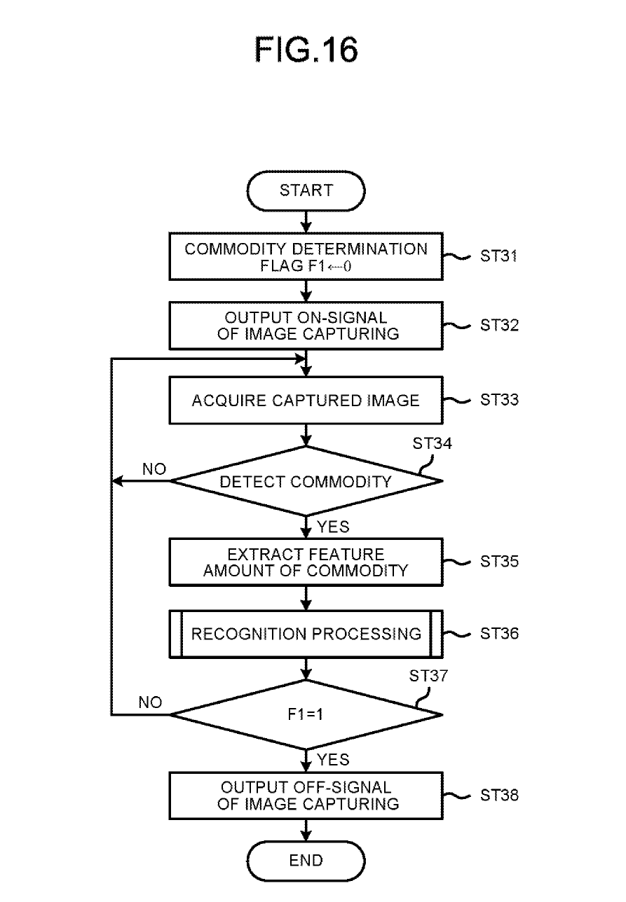

The units 81-85 are realized by the CPU 111 of the scanner apparatus 1 operating in accordance with a commodity recognition program. When the commodity recognition program is started, the CPU 111 of the scanner apparatus 1 controls each section in a procedure shown in the flowchart of FIG. 16.

In FIG. 16, ACTs ST31-34 are the same as ACTs ST1-ST4 described in embodiment 1. That is, the CPU 111 resets the commodity determination flag F1 to be “0” (ACT ST31), then the CPU 111 outputs an ON-signal of image capturing to the image capturing section 14 (ACT ST32). Then, the CPU 111 acquires a frame image (ACT ST33) and determines whether or not a commodity is contained in the frame image (ACT ST34).

If a commodity is not contained in the frame image (NO in ACT ST34), the CPU 111 acquires a next frame image from the RAM 114 (ACT ST33). Then, the CPU 111 confirms whether or not a commodity is contained in the frame image (ACT ST34).

If a commodity M is contained in the next frame image (YES in ACT ST34), the CPU 111 extracts appearance feature amount, such as the shape, the surface color, the pattern and the concave-convex situation, of the commodity M from the image in the contour extracted from the frame image (ACT ST35: feature amount extraction unit 81). After the appearance feature amount is extracted, the CPU 111 starts a recognition processing (ACT ST36).

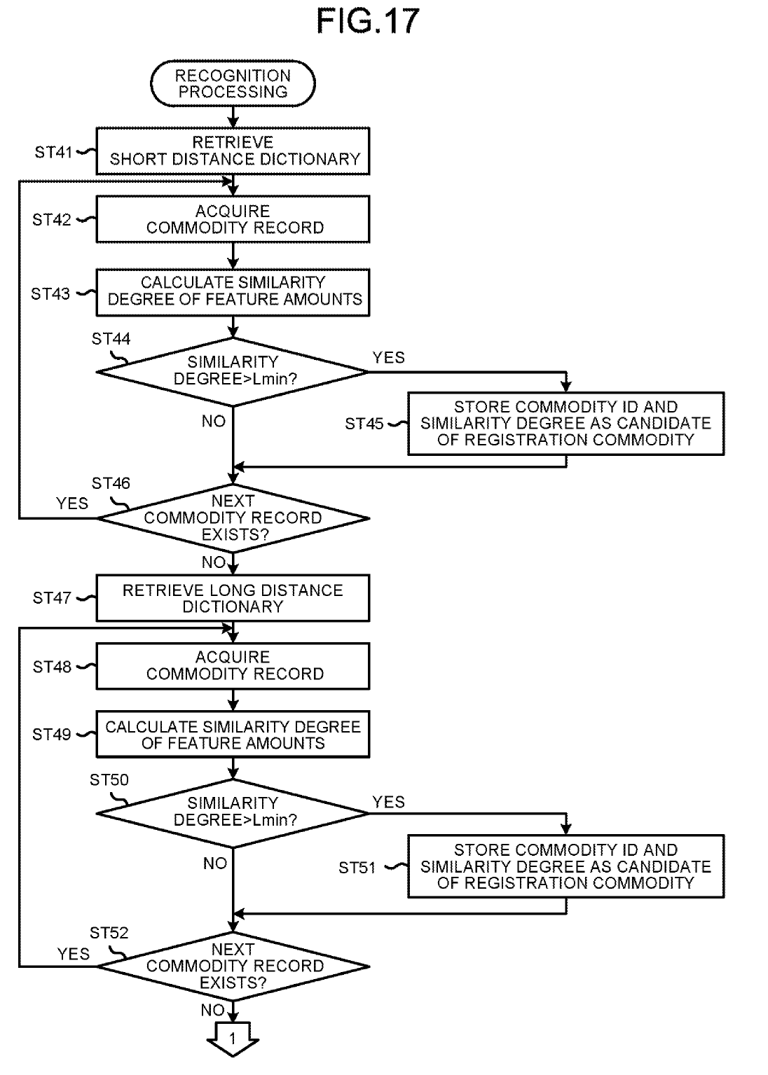

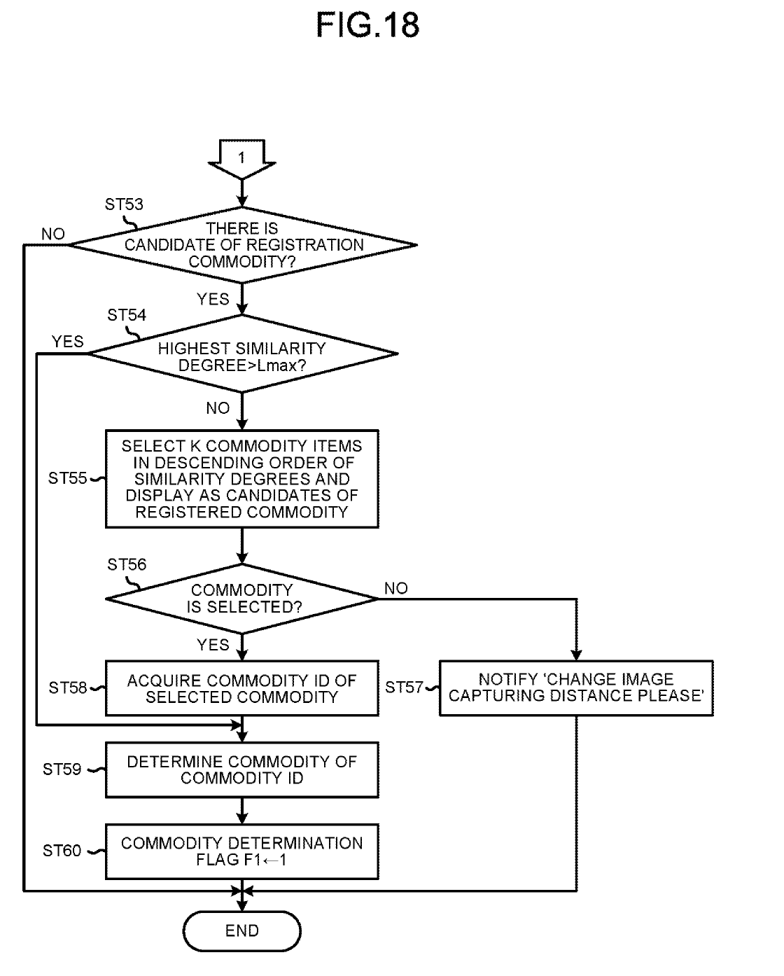

FIG. 17 and FIG. 18 are flowcharts illustrating procedures of the recognition processing. First, the CPU 111 accesses the auxiliary storage section 205 of the POS terminal 2 connected via the connection interface 115 and retrieves the short distance dictionary file 41 (ACT ST41). Then, the CPU 111 reads a data record (commodity ID, commodity name, feature amount data 0-n) of one commodity from the short distance dictionary file 41 (ACT ST22).

After reading a data record, the CPU 111 calculates, for each feature amount data 0-n of the record, a similarity degree representing how similar the appearance feature amount of the commodity extracted in ACT ST35 is to the feature amount data 0-n. Then, the CPU 111 determines the highest similarity degree calculated for each feature amount data 0-n as the similarity degree between the detected commodity M and the commodity specified with the commodity ID in the record (ACT ST43: similarity degree calculation unit 82). Further, the determined similarity degree may be a total value or an average value of the similarity degrees calculated for each feature amount data 0-n, but not limited to be the highest similarity degree calculated for each feature amount data 0-n.

The CPU 111 confirms whether or not the similarity degree determined in ACT ST43 is greater than a preset candidate threshold value Lmin (ACT ST44). If the similarity degree is not greater than the candidate threshold value Lmin (NO in ACT ST44), the CPU 111 carries out the processing in ACT ST46.

If the similarity degree is greater than the candidate threshold value Lmin (YES in ACT ST44), the CPU 111 stores the commodity ID in the record and the similarity degree in the RAM 114 as data of a candidate of a registration commodity (candidate of a recognized commodity) (ACT ST45). Then, the CPU 111 carries out the processing in ACT ST46.

In ACT ST46, the CPU 111 confirms whether or not there is an unprocessed data record in the short distance dictionary file 41. If there is an unprocessed data record in the short distance dictionary file 41 (YES in ACT ST46), the CPU 111 returns to carry out the processing in ACT ST42. That is, the CPU 111 reads the unprocessed data record from the short distance dictionary file 41 and executes the processing shown in ACT ST43-ACT ST45.

If there is no unprocessed data record in the short distance dictionary file 41, that is, the retrieval in the short distance dictionary file 41 is ended (NO in ACT ST46), the CPU 111 retrieves the long distance dictionary file 42 (ACT ST47). Then, in ACT ST48-ACT ST52, the CPU 111 executes the processing the same as that executed to the short distance dictionary file 41 in ACT ST42-ACT ST46.

If the retrieval in the long distance dictionary file 42 is ended (NO in ACT ST52), the CPU 111 confirms whether or not data of candidates of a registration commodity is stored in the RAM 114 (ACT ST53). The current recognition processing is ended if data of candidates of a registration commodity is not stored in the RAM 114 (NO in ACT ST53).

If the data of the candidates of a registration commodity is stored in the RAM 114 (YES in ACT ST53), the CPU 111 confirms whether or not the highest similarity degree of the data of the candidates of a registration commodity stored in the RAM 114 is greater than a preset determination threshold value Lmax (Lmax>Lmin) (ACT ST54). If the highest similarity degree is not greater than the determination threshold value Lmax (NO in ACT ST54), the CPU 111 selects, in the descending order of similarity degrees, the top K (K>2) commodity items from the data of the candidates of a registration commodity stored in the RAM 114. Then, the CPU 111 displays the selected top K commodity items on the display 12a as a commodity list of candidates of a registration commodity (ACT ST55: candidate output unit 83). Sequentially, the CPU 111 confirms whether or not a commodity is optionally selected from the commodity list (ACT ST56). For example, the CPU 111 gives a sound guidance from the speaker 17, for example, a sound of “change the image capturing distance please” to instruct an operator to change the image capturing distance (ACT ST57: warning unit 85).

On the other hand, if a commodity is optionally selected from the commodity list of candidates of a registration commodity by operating the touch panel 12 or the keyboard 11 (YES in ACT ST56), the CPU 111 acquires the commodity ID of the selected commodity from the RAM 114 (ACT ST58). Then, the CPU 111 determines the acquired commodity ID as the commodity ID of a commodity for sale and sends the acquired commodity ID to the POS terminal 2 via a communication cable 300 (ACT ST59: determination unit 84). Further, the CPU 111 sets the commodity determination flag F1 to be 1 (ACT ST60).

Further, in ACT ST54, if the highest similarity degree of the data of the candidates of a registration commodity is greater than the determination threshold value Lmax (YES in ACT ST54), the CPU 111 proceeds to carry out the processing in ACT ST59. That is, the CPU 111 acquires the commodity ID of the commodity having the highest similarity degree from the RAM 114. Then the CPU 111 determines the acquired commodity ID as the commodity ID of a commodity for sale and sends the acquired commodity ID to the POS terminal 2 via a communication cable 300 (ACT ST59). Further, the CPU 111 sets the commodity determination flag F1 to be 1 (ACT ST60). In addition, the ACT ST59 and ACT ST60 may be carried out in an inverse sequence.

Then, the current recognition processing is ended.

When the recognition processing is ended, the CPU 111 confirms whether or not the commodity determination flag F1 is set to be 1 (ACT ST37). If the commodity determination flag F1 is not set to be 1 (NO in ACT ST37), the CPU 111 returns to carry out ACT ST33. That is, the CPU 111 acquires another frame image stored in the RAM 114 (ACT ST33). Then, the CPU 11 executes the processing following ACT ST34 again.

If the commodity determination flag F1 is set to be 1 (YES in ACT ST37), the CPU 111 outputs an OFF-signal of image capturing to the image capturing section 14 (ACT ST38). The image capturing section 14 stops image capturing according to the OFF-signal of image capturing. Then, the commodity recognition program is ended.

In the present embodiment, the dictionary data for each commodity of a recognition target commodity of which a proper image capturing distance is shorter than the threshold value distance Dx is stored in the short distance dictionary file 41. The dictionary data for each commodity of a recognition target commodity of which a proper image capturing distance is longer than the threshold value distance Dx is stored in the long distance dictionary file 42. Then, when a commodity M is held to the reading window 1B, the similarity degree between the feature amount data of the dictionary data for each commodity registered in both the short distance dictionary file 41 and the long distance dictionary file 42 and the appearance feature amount of a commodity image extracted from a captured image is calculated in the scanner apparatus 1 regardless of the image capturing distance between the commodity M and the image capturing section 14.

Thus, a commodity of a small size, of which a proper image capturing distance is shorter than the threshold value distance Dx as the commodity has a small size, is recognized at a high recognition rate when the commodity is held close to the reading window 1B, that is, when he image capturing distance is shorter than the threshold value distance Dx. However, the recognition rate is low when the commodity is held to the reading window 1B at a distance longer than the threshold value distance Dx. In this case, a warning such as ‘change image capturing distance please’ is given, thus, a user may approach the commodity closer to the reading window 1B. Consequentially, the commodity is recognized at a high recognition rate.

On the other hand, a commodity of a large size, of which a proper image capturing distance is longer than the threshold value distance Dx as the commodity has a large size, is recognized at a high recognition rate when the commodity is held to the reading window 1B at a distance longer than the threshold value distance Dx. However, the recognition rate is low when the commodity is held close to the reading window 1B, that is, when the image capturing distance is shorter than the threshold value distance Dx. In this case, the same warning is given, thus, a user may move the commodity further away from the reading window 1B, and consequentially, the commodity is recognized at a high recognition rate.

In this way, the scanner apparatus 1 is also capable of recognizing a commodity at a high recognition rate in embodiment 2.

In addition, the present invention is not limited to the embodiments above.

For example, in embodiment 2, in a recognition processing, the short distance dictionary file 41 is retrieved first (ACT ST41-ACT ST46), and then the long distance dictionary file 42 is retrieved (ACT ST47-ACT ST52), however, it is also applicable that the long distance dictionary file 42 is retrieved first (ACT ST47-ACT ST52), and then the short distance dictionary file 41 is retrieved (ACT ST41-ACT ST46).

Further, in embodiment 1, the short distance dictionary file 31, the moderate distance dictionary file 32 and the long distance dictionary file 33 are set as recognition dictionary files 30, and in embodiment 2, the short distance dictionary files 41 and the long distance dictionary files 42 are set as recognition dictionary files 40, however, no limitation is given to the number of the recognition dictionary files for each distance. If more than four kinds of recognition dictionary files are set, the recognition rate is increased further.

Further, in the aforementioned embodiments, the scanner apparatus 1 has all the functions of a commodity recognition apparatus, however, the scanner apparatus 1 and the POS terminal 2 may dispersedly have part of the functions of a commodity recognition apparatus. Alternatively, the scanner apparatus 1 may be incorporated in and integrated with the POS terminal 2 so that the integrated apparatus can function as a commodity recognition apparatus. Further, the commodity recognition program for realizing the functions of the present invention may be completely or partially stored in an external apparatus of a store server and the like. Further, although a stationary type scanner is described in the embodiment, a portable scanner is also applicable.

Further, in the aforementioned embodiments, the commodity recognition program for realizing the functions of the present invention is pre-recorded in a ROM in the apparatus serving as a program storage section. However, the present invention is not limited to this; the same program may also be downloaded to the apparatus from a network. Alternatively, the same program recorded in a recording medium may be installed in the apparatus. The recording medium may be in any form as long as the recording medium can store programs like a CD-ROM and a memory card and is readable to the apparatus. Further, the functions achieved by an installed or downloaded program can also be realized through cooperation with an OS (Operating System) installed in the apparatus. Moreover, the program described in the present embodiment may be incorporated in a portable information terminal such as a portable telephone having a communication function or the called PDA to realize the functions.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A commodity recognition apparatus, comprising:
a feature amount extraction unit configured to extract an appearance feature amount of a commodity contained in an image captured by an image capturing section for capturing a commodity;
a distance measurement unit configured to measure the distance from the image capturing section to a commodity captured by the image capturing section;
a file selection unit configured to select a recognition dictionary file corresponding to the distance measured by the distance measurement unit from the recognition dictionary files for each distance which store, for each image capturing distance when capturing a recognition target commodity, feature amount data representing the surface information of the recognition target commodity obtained from a reference image of the recognition target commodity captured at the image capturing distance;
a similarity degree calculation unit configured to calculate, for each recognition target commodity, a similarity degree representing how similar the appearance feature amount is to the feature amount data by comparing the appearance feature amount extracted by the feature amount extraction unit with the feature amount data of the recognition dictionary file selected by the file selection unit; and
a candidate output unit configured to output a recognition target commodity as a candidate of a recognized commodity based on the similarity degrees calculated by the similarity degree calculation unit.

2. The commodity recognition apparatus according to claim 1, wherein
the candidate output unit displays and outputs a recognition target commodity of the candidates of a recognized commodity to be selectable;
comprising:
a first determination unit configured to determine the recognition target commodity selected from the candidates of a recognized commodity as a commodity captured by the image capturing section.

3. The commodity recognition apparatus according to claim 1, wherein
the information is stored to identify whether or not the feature amount data of each recognition target commodity stored in the recognition dictionary files for each distance is acquired from a reference image captured at a proper image capturing distance for the commodity;
further comprising:
a second determination unit configured to determine, in a case where the highest similarity degree of the recognition target commodity output by the candidate output unit as a candidate of a recognized commodity is above a preset determination value and the highest similarity degree is calculated according to the feature amount data acquired from the reference image captured at the proper image capturing distance, the recognition target commodity having the highest similarity degree as a commodity captured by the image capturing section.

4. A commodity recognition apparatus, comprising:
a feature amount extraction unit configured to extract an appearance feature amount of a commodity contained in an image captured by an image capturing section for capturing a commodity;
a similarity degree calculation unit configured to calculate, for each recognition target commodity, a similarity degree representing how similar the appearance feature amount is to the feature amount data by comparing the appearance feature amount extracted by the feature amount extraction unit with the feature amount data of the recognition dictionary file for each distance which stores, for each image capturing distance when capturing a recognition target commodity, feature amount data representing the surface information of the recognition target commodity obtained from a reference image of the recognition target commodity captured at the image capturing distance; and
a candidate output unit configured to output a recognition target commodity as a candidate of a recognized commodity based on the similarity degrees calculated by the similarity degree calculation unit.

5. The commodity recognition apparatus according to claim 4, wherein
the candidate output unit displays and outputs a recognition target commodity of the candidates of a recognized commodity to be selectable;
further comprising:
a warning unit configured to give a warning to change the distance between a commodity captured by the image capturing section and the image capturing section when the commodity captured by the image capturing section is not selected from the candidates of a recognized commodity.

6. A commodity recognition method, comprising:
extracting an appearance feature amount of a commodity contained in an image captured by an image capturing section for capturing a commodity;
selecting a recognition dictionary file corresponding to the distance from the image capturing section to a commodity captured by the image capturing section measured by a distance measurement unit from the recognition dictionary files for each distance which store, for each image capturing distance when capturing a recognition target commodity, feature amount data representing the surface information of the recognition target commodity obtained from a reference image of the recognition target commodity captured at the image capturing distance;
calculating, for each recognition target commodity, a similarity degree representing how similar the appearance feature amount is to the feature amount data by comparing the extracted appearance feature amount with the feature amount data of the selected recognition dictionary file; and
outputting a recognition target commodity as a candidate of a recognized commodity based on the calculated similarity degrees.
